(19) United States
(12) Patent Application Publication
(10) Pub. No.: US 2003/0157974 A1
(43) Pub. Date: Aug. 21, 2003

(54) Urgent power-supply arrangement using cascaded wireless mobile devices

(75) Inventor: Shih Chieh Lin, Taipei (TW)

Correspondence Address: BACON & THOMAS, PLLC, 625 SLATERS LANE, FOURTH FLOOR, ALEXANDRIA, VA, 22314

(73) Assignee: INSTITUTE FOR INFORMATION INDUSTRY, Taipei (TW)

(21) Appl. No.: 10/075,297

(22) Filed: Feb. 15, 2002

(51) Int. Cl. H04M 1/00

(52) U.S. Cl. 455/572; 455/573

(57) ABSTRACT

An urgent power-supply arrangement using cascaded wireless mobile devices is provided. A first wireless mobile device has a load device and a battery device for supplying power to the load device. A second wireless mobile device is powered by a battery device. The second wireless mobile device is electrically connected to the first mobile device such that the battery device of the first wireless mobile device is cascaded with the battery device of the second wireless mobile device for supplying power to the load device of the first wireless mobile device.

### BACKGROUND OF THE INVENTION

1. Field of the Invention

The present invention relates to a power-supply device for a wireless mobile device and, more particularly, to an urgent power-supply arrangement using cascaded wireless mobile devices.

2. Description of Related Art

Currently, the wireless mobile devices, such as mobile phones, are in wide spread use in our daily life to dramatically increase the convenience of communication. With a mobile phone, the user can communicate with other people in anywhere and at anytime. However, there are still some limitations in use of the mobile phone. For example, when the battery power of the mobile phone is exhausted, the mobile phone cannot work normally until replacing or re-charging the exhausted battery. Unfortunately, in a critical situation or urgent circumstance, it is not realistic to expect to recharge the battery or to have a new battery. Accordingly, there is a need to provide a novel design for providing an urgent power-supply arrangement to mitigate and/or obviate the aforementioned problems.

### SUMMARY OF THE INVENTION

The object of the present invention is to provide an urgent power-supply arrangement using cascaded wireless mobile devices for making a wireless mobile device usable, under critical situation or urgent circumstance, even though its battery power is exhausted.

To achieve the object, the urgent power-supply arrangement using cascaded wireless mobile devices includes: a first wireless mobile device having a load device and a battery device for supplying power to the load device; and at least one second wireless mobile device powered by a battery device, wherein the second wireless mobile device is electrically connected to the first mobile device such that the battery device of the first wireless mobile device is cascaded with the battery device of the second wireless mobile device for supplying power to the load device of the first wireless mobile device.

Other objects, advantages, and novel features of the invention will become more apparent from the following detailed description when taken in conjunction with the accompanying drawings.

### BRIEF DESCRIPTION OF THE DRAWINGS

FIG. 1 schematically illustrates an urgent power-supply arrangement using cascaded wireless mobile devices in accordance with a preferred embodiment of the present invention;

FIG. 2 schematically illustrates the battery connection configuration of the urgent power-supply arrangement using cascaded wireless mobile devices in accordance with a preferred embodiment of the present invention.

### DETAILED DESCRIPTION OF THE PREFERRED EMBODIMENT

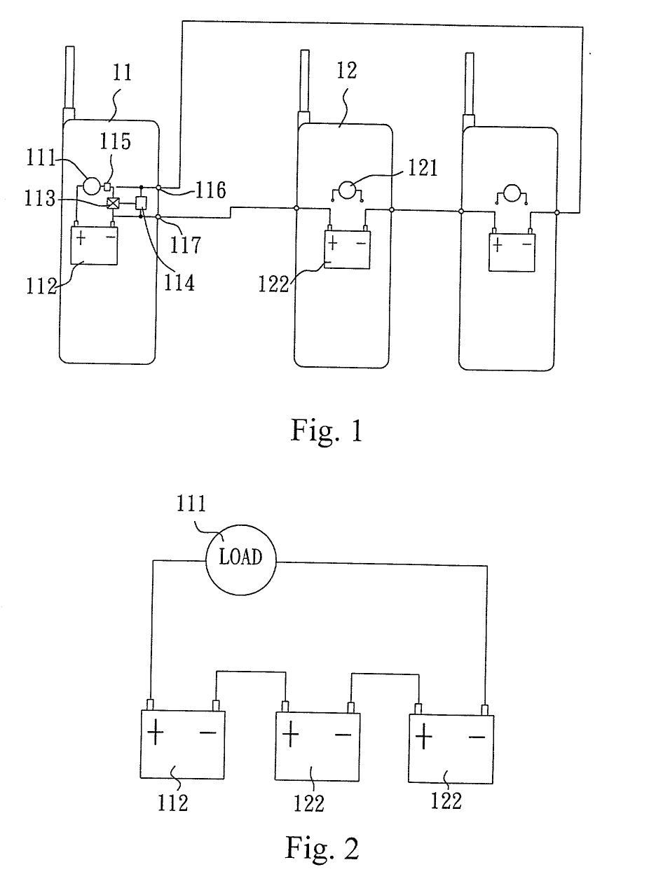

Referring now to FIG. 1, a preferred embodiment of the urgent power-supply arrangement using cascaded wireless mobile devices in accordance with the present invention is illustrated. As shown, there is a first wireless mobile device 11 and at least one second wireless mobile device 12. The first wireless mobile device represents a power-exhausted device and the second wireless mobile device represents a device which can be used to provide urgent power. The at least one second wireless mobile device 12 may contain a plurality of wireless mobile devices 12 having batteries cascaded together. In this preferred embodiment, there are two wireless mobile devices 12 having batteries cascaded together.

The second wireless mobile device 12 includes a load device 121 that represents the circuit of the mobile device, and a battery device 122 that supplies power to the load device 121.

The first wireless mobile device 11 includes a load device 111 that represents the circuit of the mobile device, a battery device 112 that supplies power to the load device 111, a voltage stabilizer 115 that is arranged between the load device 111 and the battery device 112, a switch device 113 that is arranged between the load device 111 and an electrode of the battery device 112, a detecting device 114, a first connector 116, and a second connector 117. The first and second connectors 116 and 117 are connected to two terminals of the switch device 113, respectively. The detecting device 114 is connected to the first and second connectors 116 and 117.

The first and second connectors 116 and 117 provided to electrically connect the first mobile device 11 and the second mobile device 12. That is, the first and second connectors 116 and 117 can be coupled to the corresponding connectors of the second mobile device 12 via conductive wires, so as to be electrically connected to the two electrodes of the battery device 122 in the second mobile device 12.

The switch device 113 is a normally closed switch, which is conducted at normal state so that the battery device 112 of the first mobile device 11 can provide power to the load 111. When the power of the battery 112 is exhausted and the supply voltage is drop off, conductive wires are used to electrically connect the first and second connectors 116 and 117 to the second mobile device 12. At this moment, the detecting device 114 of the first mobile device 11 detects the electrical connection of the first and second wireless mobile devices 11 and 12, and thus disconnects the switch device 113. Therefore, as shown in FIG. 2, the battery device 112 of the first wireless mobile device 11 is cascaded with the battery device 122 of the second wireless mobile device 12 for supplying power to the load 111 of the first mobile device 11. The voltage stabilizer can be a zener diode to provide a constant voltage effect such that the voltage of the cascaded battery devices will be limited to a specific level.

In view of the foregoing, it is known that the present invention can make use of cascading the battery devices 112 and 122 to combine multiple mobile devices which are all exhausted in battery power, so as to gather up the remained power for being supplied to one wireless mobile device, thereby enabling the wireless mobile device work normally. As a result, the present invention can solve the communication problem of exhausted wireless mobile device in critical situation or urgent circumstance.

Although the present invention has been explained in relation to its preferred embodiment, it is to be understood that many other possible modifications and variations can be made without departing from the spirit and scope of the invention as hereinafter claimed.

What is claimed is:

1. An urgent power-supply arrangement using cascaded wireless mobile devices comprising:
a first wireless mobile device having a load device and a battery device for supplying power to the load device; and
at least one second wireless mobile device powered by a battery device,
wherein the second wireless mobile device is electrically connected to the first mobile device such that the battery device of the first wireless mobile device is cascaded with the battery device of the second wireless mobile device for supplying power to the load device of the first wireless mobile device.

2. The urgent power-supply arrangement using cascaded wireless mobile devices as claimed in claim 1, wherein the at least one second wireless mobile device contains a plurality of wireless mobile devices having batteries cascaded together.

3. The urgent power-supply arrangement using cascaded wireless mobile devices as claimed in claim 1, further comprising a voltage stabilizer arranged between the load device and the battery device of the first wireless mobile device.

4. The urgent power-supply arrangement using cascaded wireless mobile devices as claimed in claim 3, wherein the voltage stabilizer is a zener diode.

5. The urgent power-supply arrangement using cascaded wireless mobile devices as claimed in claim 1, further comprising:
a switch device arranged between the load device and an electrode of the battery device of the first wireless mobile device;
a first and a second connectors connected to two terminals of the switch device, respectively, for electrically connecting the first wireless mobile device to the at least one second wireless mobile device; and
a detecting device arranged between the first connector and the second connector for disconnecting the switch device when detecting an electrical connection of the first and second wireless mobile devices, and otherwise conducting the switch device.
